(19) United States
(12) Patent Application Publication
(10) Pub. No.: US 2014/0181684 A1
(43) Pub. Date: Jun. 26, 2014

(54) MODIFYING A USER PROFILE

(71) Applicant: INTERNATIONAL BUSINESS MACHINES CORPORATION, Armonk, NY (US)

(72) Inventors: SHIVA R. DASARI, AUSTIN, TX (US); RAGHUSWAMYREDDY GUNDAM, AUSTIN, TX (US); JOSHUA H. ISRAEL, AUSTIN, TX (US); NEWTON P. LIU, AUSTIN, TX (US); DOUGLAS W. OLIVER, ROUND ROCK, TX (US); WINGCHEUNG TAM, AUSTIN, TX (US)

(73) Assignee: INTERNATIONAL BUSINESS MACHINES CORPORATION, ARMONK, NY (US)

(21) Appl. No.: 13/728,578

(22) Filed: Dec. 27, 2012

Related U.S. Application Data
(63) Continuation of application No. 13/724,638, filed on Dec. 21, 2012.

(51) Int. Cl. G06F 3/0481

(52) U.S. Cl. CPC G06F 3/0481
USPC 715/747

(57) ABSTRACT

Modifying a user profile, including: receiving, by a content presentation module, a request for one or more elements in a user profile, wherein each element in the user profile includes information identifying attributes associated with a user; presenting, by the content presentation module, content provided by a content provider; receiving, by the content presentation module, a user request to alter the presentation of the content; receiving, by the content presentation module, updated values for the requested one or more elements in the user profile; and updating, by the content presentation module, the user profile in dependence upon the updated values for the requested one or more elements in the user profile.

### CROSS-REFERENCE TO RELATED APPLICATION

This application is a continuation application of and claims priority from U.S. patent application Ser. No. 13/724,638, filed on Dec. 21, 2012.

### BACKGROUND OF THE INVENTION

1. Field of the Invention

The field of the invention is data processing, or, more specifically, methods, apparatus, and products for modifying a user profile.

2. Description Of Related Art

Modern computing devices can couple to data communications networks to communicate with other computing devices, including servers and other computing devices that can deliver content such as a web page to a user. Users may have a user profile that allows the user to have website content presented in a way that is most relevant and comprehensible to them. When a user accesses a website, the site can request profile data and, based on that information, dynamically present the website so that it is most relevant to that specific user. A user profile may contain large amounts of data. While the user has the ability to manage website content using the profile, the data within the profile may prove to be too large to manage on his/her own, as identifying pertinent entries would be difficult.

### SUMMARY OF THE INVENTION

Methods, apparatus, and products for modifying a user profile, including: receiving, by a content presentation module, a request for one or more elements in a user profile, wherein each element in the user profile includes information identifying attributes associated with a user; presenting, by the content presentation module, content provided by a content provider; receiving, by the content presentation module, a user request to alter the presentation of the content; receiving, by the content presentation module, updated values for the requested one or more elements in the user profile; and updating, by the content presentation module, the user profile in dependence upon the updated values for the requested one or more elements in the user profile.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an example computer useful in modifying a user profile according to embodiments of the present invention.

FIG. 2 sets forth a flow chart illustrating an example method for modifying a user profile according to embodiments of the present invention.

FIG. 3 sets forth a flow chart illustrating an additional example method for modifying a user profile according to embodiments of the present invention.

FIG. 4 sets forth a flow chart illustrating an additional example method for modifying a user profile according to embodiments of the present invention.

### DETAILED DESCRIPTION OF EXAMPLE EMBODIMENTS

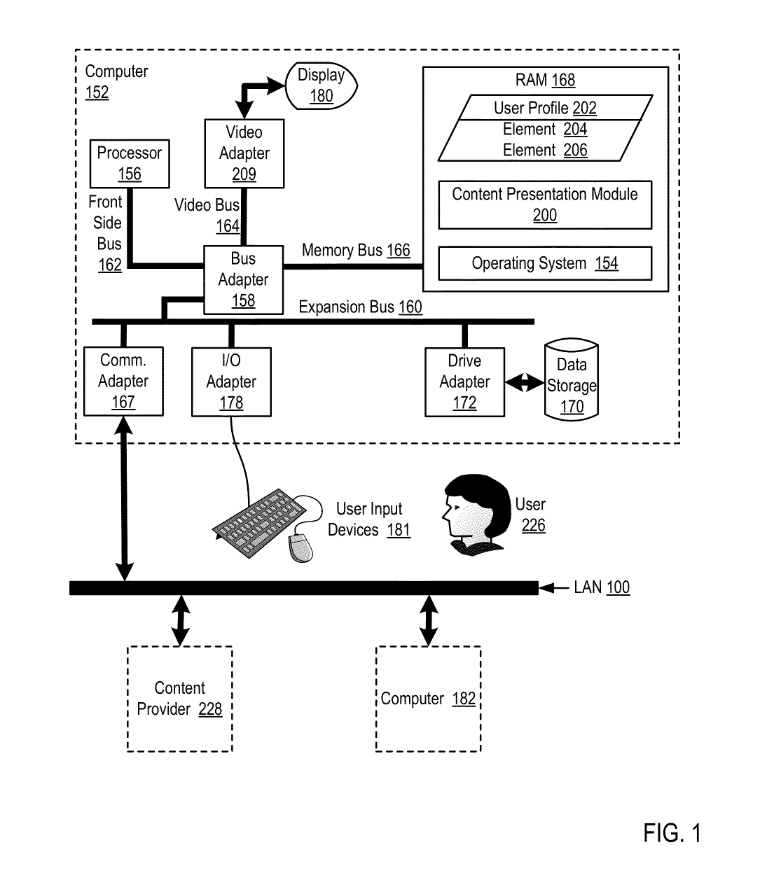

Example methods, apparatus, and products for modifying a user profile in accordance with the present invention are described with reference to the accompanying drawings, beginning with FIG. 1. Modifying a user profile in accordance with the present invention is generally implemented with computers, that is, with automated computing machinery. For further explanation, therefore, FIG. 1 sets forth a block diagram of automated computing machinery comprising an example computer (152) useful in modifying a user profile (202) according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a content presentation module (200), a module of computer program instructions for modifying a user profile (202). The content presentation module (200) may be embodied, for example, as a plugin to a web browser, as computer program instructions within the web browser, as a standalone application, and in other ways as will occur to those of skill in the art. The user profile (202) that is modified by the content presentation module (200) may be embodied, for example, as a data structure that includes values for various attributes that may be used to determine how content is presented to a user (226). For example, the user profile (202) may include information that is used by a content provider (228) to tailor the content that is delivered to the user (226). Consider an example in which the content provider (228) is a server configured to deliver a web page to the user (226). In such an example, the user profile (202) may include information that is used by the content provider (228) to personalize the web page that is delivered to the user (226). For example, the user profile (202) may include the user's location such that the web page that is delivered to the user (226) includes information of interest to users at the user's location. The user profile (202) may include additional information such as, for example, the user's age, the user's education level, the user's interests, and many others.

In the example of FIG. 1, the content presentation module (200) can modify the user profile (202) by receiving a request for one or more elements (204, 206) in a user profile (202). Each element (204, 206) in the user profile (202) includes information identifying attributes associated with a user (226). The request for one or more elements (204, 206) in a user profile (202) may be received, for example, from the content provider (228) in response to the content presentation module (200) issuing a request for content from the content provider (228). The request for one or more elements (204, 206) in a user profile (202) may include information identifying the relevant user profile (202), information identifying the specific elements (204, 206) within the user profile (202) that are requested, information identifying the requestor, and so on.

In the example of FIG. 1, the content presentation module (200) can further modify the user profile (202) by presenting content consumed by the content provider (228) in displaying a particular website. The content provided by the content provider (228) may be modified in dependence upon values contained in the user profile (202) that were presented to the content provider (228) in response to the content provider's request for one or more elements (204, 206) in a user profile (202). The content provided by the content provider (228) may be presented to the user (226), for example, by rendering the content in a web browser.

In the example of FIG. 1, the content presentation module (200) can further modify the user profile (202) by receiving a user request to alter the presentation of the content. The user request to alter the presentation of the content may be received, for example, in response to presenting a prompt to the user (226) asking the user (226) if the presentation of the content should be altered. For example, upon presenting the content provided by the content provider (228) to the user (226), the content presentation module (200) may generate a graphical user interface that asks the user (226) if they would like to change one or more aspects of the content that is presented to the user (226).

In the example of FIG. 1, the content presentation module (200) can further modify the user profile (202) by receiving updated values for the requested one or more elements (204, 206) in the user profile (202). The updated values for the requested one or more elements (204, 206) in the user profile (202) may be received, for example, through a graphical user interface presented to the user (226) in response to the receiving a user request to alter the presentation of the content. The updated values that are received include values only for the one or more elements (204, 206) in the user profile (202) that were requested in the request that was received by the content presentation module. That is, although the user profile (202) may include many elements identifying a wide variety of information related to the user (226) and the user's preferences, only those elements that were identified in the request that was received by the content presentation module (200) will be available for updating.

Consider an example in which a user profile (202) includes information identifying the location of the user (226), the age of the user (226), the educational level of the user (226), the expertise level of the user (226) with respect to a first topic, and the expertise level of the user (226) with respect to a second topic. In such an example, assume that the content provider (228) issued a request for the educational level of the user (226) and the expertise level of the user (226) with respect to the first topic. Because the request that was received by the content presentation module (200) was only a request for the educational level of the user (226) and the expertise level of the user (226) with respect to the first topic, the user (226) may only provide updated values for the educational level of the user (226) and the expertise level of the user (226) with respect to the first topic. Stated differently, the location of the user (226), the age of the user (226), and the expertise level of the user (226) with respect to a second topic have no relevance and no impact on the generation of the content whose presentation the user (226) has requested to change. By permitting the user (226) to provide updated values only for the one or more elements (204, 206) from the user profile (202) that were requested during the generation of the content, the user (226) may not inadvertently alter values in the user profile (202) that were not used to generate the content whose presentation the user (226) has requested to change.

In the example of FIG. 1, the content presentation module (200) can further modify the user profile (202) by updating the user profile (202) in dependence upon the updated values for the requested one or more elements (204, 206) in the user profile (202). Updating the user profile (202) in dependence upon the updated values for the requested one or more elements (204, 206) in the user profile (202) may be carried out, for example, by replacing values contained in the user profile (202) with the updated values for the requested one or more elements (204, 206).

Continuing with the example described above in which the content provider (228) issued a request for the educational level of the user (226) and the expertise level of the user (226) with respect to the first topic, assume that the user profile (202) included a value of ‘novice’ in the element of the user profile (202) identifying the expertise level of the user (226) with respect to the first topic. In such an example, the content provider (228) may have generated content that included only introductory level material with respect to the first topic. Upon reading the content, however, the user (226) may desire to change the value in the element of the user profile (202) identifying the expertise level of the user (226) with respect to the first topic. In such an example, the updated value for such an element may be set to a value of ‘intermediate,’ such that the user profile (202) may be updated such that the value of the element of the user profile (202) identifying the expertise level of the user (226) with respect to the first topic is set to ‘novice.’ In such an example, additional requests for this information from the content provider (228) will result in the content provider (228) generating content that includes intermediate level material with respect to the first topic.

Also stored in RAM (168) is an operating system (154). Operating systems useful in modifying a user profile (202) according to embodiments of the present invention include UNIX™, Linux™, Microsoft XP™, AIX™, IBM's i5/OS™, and others as will occur to those of skill in the art. The operating system (154) and the content presentation module (200) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for modifying a user profile (202) according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example computer (152) of FIG. 1 includes a communications adapter (167) for data communications with other computers (182) and content providers (228) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for modifying a user profile according to embodiments of the present invention include modems for wired dial-up communications, Ethernet (IEEE 802.3) adapters for wired data communications network communications, and 802.11 adapters for wireless data communications network communications.

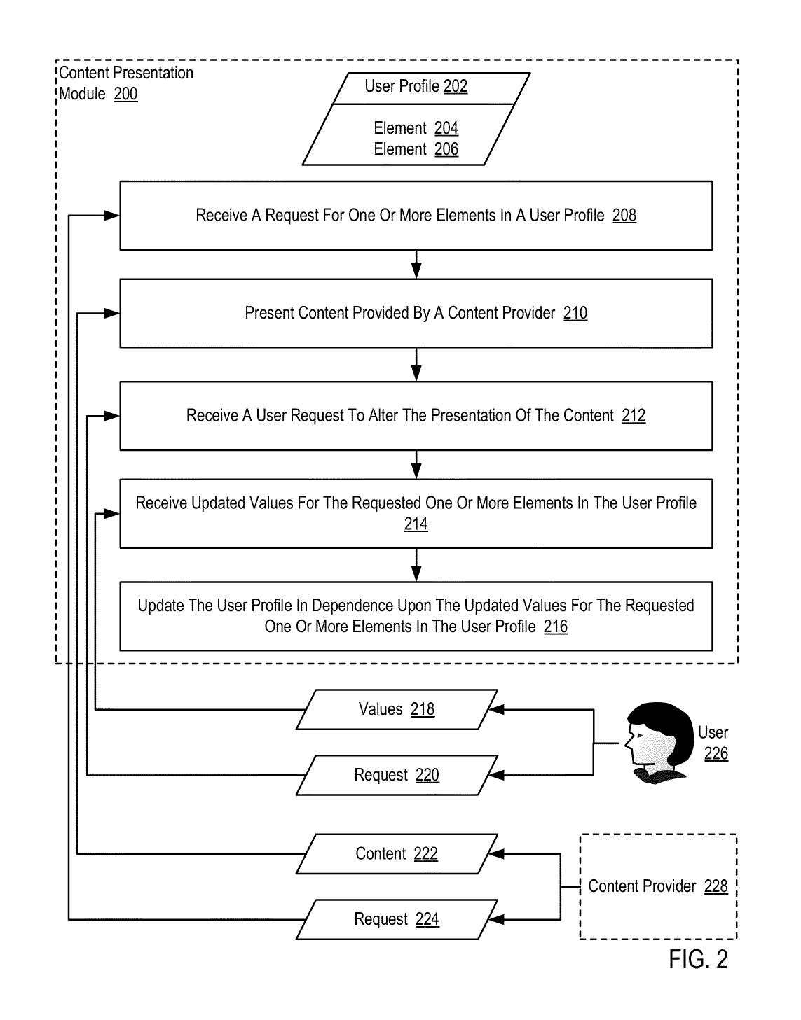

For further explanation, FIG. 2 sets forth a flow chart illustrating an example method for modifying a user profile (202) according to embodiments of the present invention. The example method of FIG. 2 is carried out by a content presentation module (200). In the example method of FIG. 2, the content presentation module (200) may be embodied as a module of computer program instructions for maintaining and modifying a user profile (202). The content presentation module (200) may be embodied, for example, as a plugin to a web browser, as computer program instructions within the web browser, as a standalone application, and in other ways as will occur to those of skill in the art.

In the example method of FIG. 2, the user profile (202) that is modified by the content presentation module (200) may be embodied, for example, as a data structure that includes values for various attributes that may be used to determine how content is presented to a user (226). For example, the user profile (202) may include information that is used by a content provider (228) to tailor the content that is delivered to the user (226). Consider an example in which the content provider (228) is a server configured to deliver a web page to the user (226). In such an example, the user profile (202) may include information that is used by the content provider (228) to personalize the web page that is delivered to the user (226). For example, the user profile (202) may include the user's location such that the web page that is delivered to the user (226) includes information of interest to users at the user's location. The user profile (202) may include additional information such as, for example, the user's age, the user's education level, the user's interests, and many others.

The example method of FIG. 2 includes receiving (208), by a content presentation module (200), a request (224) for one or more elements (204, 206) in a user profile (202). In the example method of FIG. 2, each element (204, 206) in the user profile (202) includes information identifying attributes associated with a user (226). The request (224) for one or more elements (204, 206) in a user profile (202) may be received (208), for example, from a content provider (228) in response to the content presentation module (200) issuing a request for content from the content provider (228). In the example method of FIG. 2, the request (224) for one or more elements (204, 206) in a user profile (202) may include information identifying the relevant user profile (202), information identifying the specific elements (204, 206) within the user profile (202) that are requested, information identifying the requestor, and so on.

The example method of FIG. 2 also includes presenting (210), by the content presentation module (200), content (222) provided by a content provider (228). In the example method of FIG. 2, the content (222) provided by the content provider (228) may be modified in dependence upon values contained in the user profile (202) that were presented to the content provider (228) in response to the content provider's request (224) for one or more elements (204, 206) in a user profile (202). The content (222) provided by the content provider (228) may be presented (210) to the user (226), for example, by rendering the content in a web browser.

The example method of FIG. 2 also includes receiving (212), by the content presentation module (200), a user request (220) to alter the presentation of the content (222). In the example method of FIG. 2, the user request (220) to alter the presentation of the content (222) may be received (212), for example, in response to presenting a prompt to the user (226) asking the user (226) if the presentation of the content (222) should be altered. For example, upon presenting (210) the content (222) provided by a content provider (228) to the user (226), the content presentation module (200) may generate a graphical user interface that asks the user (226) if they would like to change one or more aspects of the content (222) that is presented to the user (226).

The example method of FIG. 2 also includes receiving (214), by the content presentation module (200), updated values (218) for the requested one or more elements (204, 206) in the user profile (202). In the example method of FIG. 2, the updated values (218) for the requested one or more elements (204, 206) in the user profile (202) may be received (214), for example, through a graphical user interface presented to the user (226) in response to the receiving (212) a user request (220) to alter the presentation of the content (222). In the example method of FIG. 2, the updated values (218) that are received (214) include values only for the one or more elements (204, 206) in the user profile (202) that were requested in the request (224) that was received (208) by the content presentation module (200). That is, although the user profile (202) may include many elements identifying a wide variety of information related to the user (226) and the user's preferences, only those elements that were identified in the request (224) that was received (208) by the content presentation module (200) will be available for updating.

Consider an example in which a user profile (202) includes information identifying the location of the user (226), the age of the user (226), the educational level of the user (226), the expertise level of the user (226) with respect to a first topic, and the expertise level of the user (226) with respect to a second topic. In such an example, assume that the content provider (228) issued a request (224) for the educational level of the user (226) and the expertise level of the user (226) with respect to the first topic. Because the request (224) received (208) by the content presentation module (200) was only a request (224) for the educational level of the user (226) and the expertise level of the user (226) with respect to the first topic, the user (226) may only provide updated values (218) for the educational level of the user (226) and the expertise level of the user (226) with respect to the first topic. Stated differently, the location of the user (226), the age of the user (226), and the expertise level of the user (226) with respect to a second topic have no relevance and no impact on the generation of the content (222) whose presentation the user (226) has requested to change. By permitting the user (226) to provide updated values (218) only for the one or more elements (204, 206) from the user profile (202) that were requested during the generation of the content (222), the user (226) may not inadvertently alter values in the user profile (202) that were not used to generate the content (222) whose presentation the user (226) has requested to change.

The example method of FIG. 2 also includes updating (216), by the content presentation module (200), the user profile (202) in dependence upon the updated values (218) for the requested one or more elements (204, 206) in the user profile (202). In the example method of FIG. 2, updating (216) the user profile (202) in dependence upon the updated values (218) for the requested one or more elements (204, 206) in the user profile (202) may be carried out, for example, by replacing values contained in the user profile (202) with the updated values (218) for the requested one or more elements (204, 206).

Continuing with the example described above in which the content provider (228) issued a request (224) for the educational level of the user (226) and the expertise level of the user (226) with respect to the first topic, assume that the user profile (202) included a value of ‘novice’ in the element of the user profile (202) identifying the expertise level of the user (226) with respect to the first topic. In such an example, the content provider (228) may have generated content (222) that included only introductory level material with respect to the first topic. Upon reading the content (222), however, the user (226) may desire to change the value in the element of the user profile (202) identifying the expertise level of the user (226) with respect to the first topic. In such an example, the updated value (218) for such an element may be set to a value of ‘intermediate,’ such that the user profile (202) may be updated (216) such that the value of the element of the user profile (202) identifying the expertise level of the user (226) with respect to the first topic is set to ‘novice.’ In such an example, additional requests (224) for this information from the content provider (228) will result in the content provider (228) generating content (222) that includes intermediate level material with respect to the first topic.

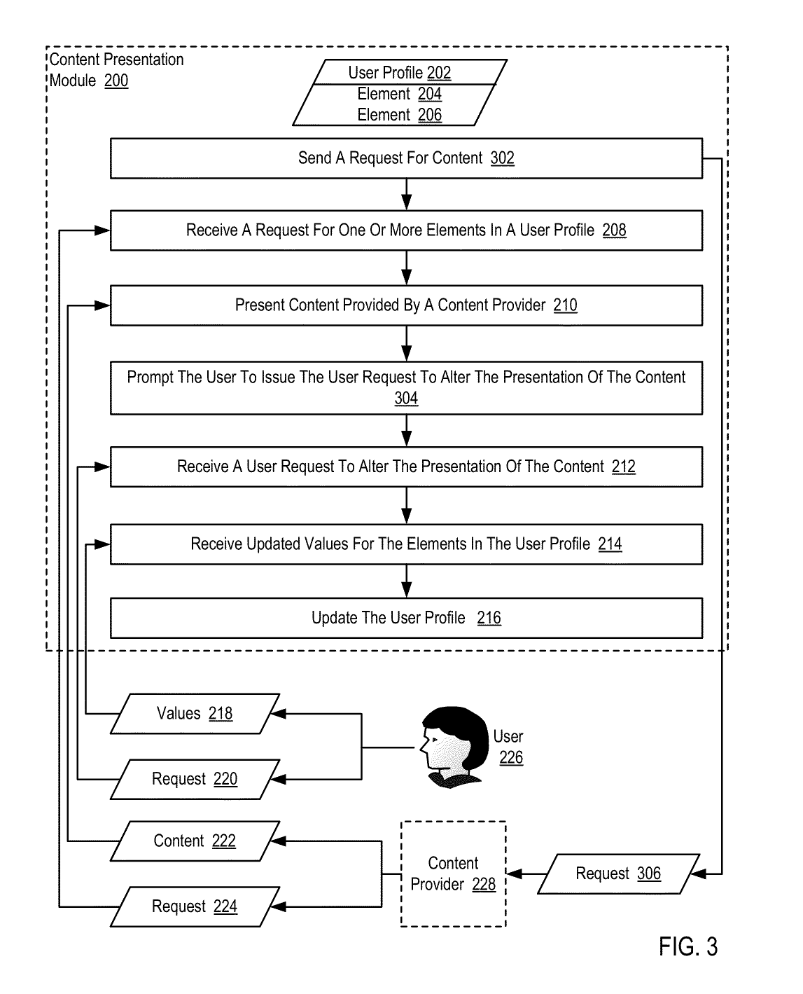

For further explanation, FIG. 3 sets forth a flow chart illustrating an example method for modifying a user profile (202) according to embodiments of the present invention. The example method of FIG. 3 is similar to the example method of FIG. 2 as it also includes receiving (208) a request (224) for one or more elements (204, 206) in a user profile (202), presenting (210) content (222) provided by a content provider (228), receiving (212) a user request (220) to alter the presentation of the content (222), receiving (214) updated values (218) for the requested one or more elements (204, 206) in the user profile (202), and updating (216) the user profile (202) in dependence upon the updated values (218) for the requested one or more elements (204, 206) in the user profile (202).

In the example method of FIG. 3, the requested one or more elements (204, 206) in the user profile (202) include only a subset of all elements (204, 206) in the user profile (202). As described above, a user profile (202) may include a large number of elements that are associated with the user (226) and the user's preferences relating to the presentation of content to the user (226). In fact, some elements in the user profile (202) may be very specific to a particular content provider (228) such that only some elements in the user profile (202) are utilized by a particular content provider (228) when tailoring content (222) to be presented to a particular user (226). As such, the request (224) issued by the content provider (228) and received (208) by the content presentation module (200) may therefore only a subset of all elements (204, 206) in the user profile (202).

The example method of FIG. 3 also includes sending (302), by the content presentation module (200), a request (306) for content. In the example method of FIG. 3, the request (306) for content may be embodied as a hypertext transfer protocol (‘HTTP’) request issued in response to the user (226) attempting to access a web resource, such as a web page, via a web browser. In such an example, the request (306) for content may be sent (302) to a content provider (228), thereby triggering the content provider (228) to issue a request (224) for one or more elements (204, 206) in the user profile (202) so that the content provider (228) can generate content (222) to be delivered to the user (226) that is tailored for the user (226).

The example method of FIG. 3 also includes prompting (304), by the content presentation module (200), the user (226) to issue the user request (220) to alter the presentation of the content (222). In the example method of FIG. 3, prompting (304) the user (226) to issue the user request (220) to alter the presentation of the content (222) may be carried out, for example, by the content presentation module (200) generating a graphical user interface that asks the user (226) if they would like to change one or more aspects of the content (222) that is presented to the user (226). Such a graphical user interface may also include information identifying the one or more elements (204, 206) in the user profile (202) that were identified in the request (224) received (208) by the content presentation module (200). The graphical user interface may also include text boxes, drop down lists, and other input fields that allow the user (226) to specify an updated value (218) for one or more of the elements (204, 206) in the user profile (202) that were identified in the request (224) that was received (208) by the content presentation module (200).

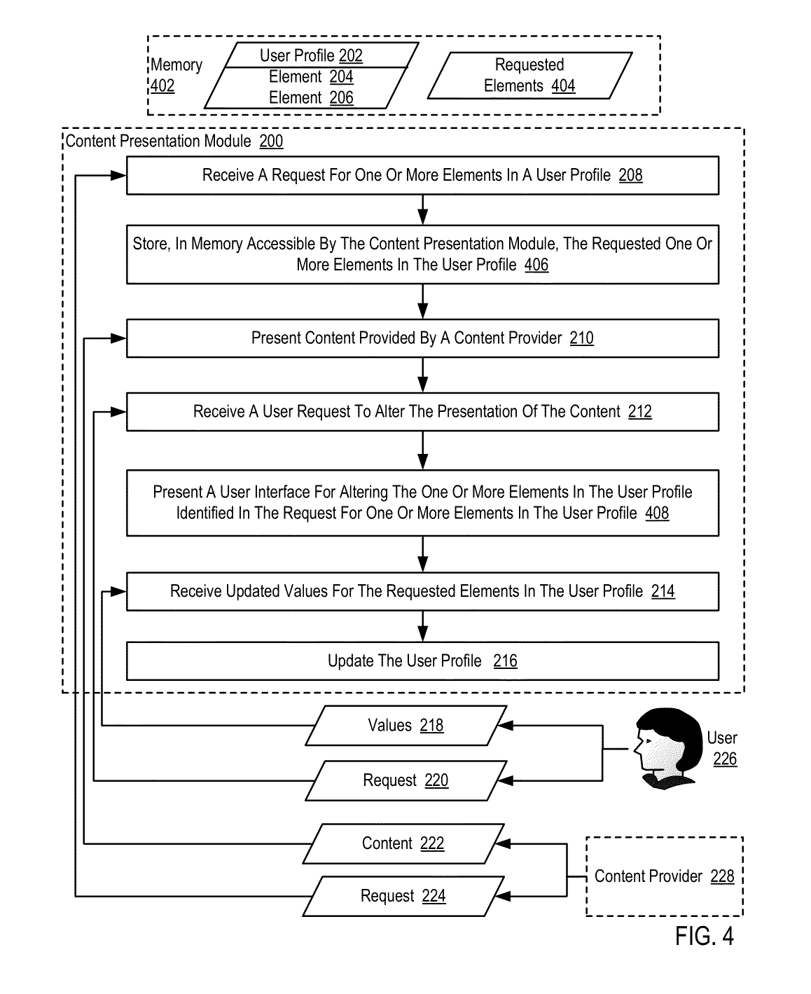

For further explanation, FIG. 4 sets forth a flow chart illustrating an example method for modifying a user profile (202) according to embodiments of the present invention. The example method of FIG. 4 is similar to the example method of FIG. 2 as it also includes receiving (208) a request (224) for one or more elements (204, 206) in a user profile (202), presenting (210) content (222) provided by a content provider (228), receiving (212) a user request (220) to alter the presentation of the content (222), receiving (214) updated values (218) for the requested one or more elements (204, 206) in the user profile (202), and updating (216) the user profile (202) in dependence upon the updated values (218) for the requested one or more elements (204, 206) in the user profile (202).

The example method of FIG. 4 also includes storing (406), by the content presentation module (200) in memory (402) accessible by the content presentation module (200), the requested one or more elements (404) in the user profile (202). In the example method of FIG. 4, the memory (402) accessible by the content presentation module (200) may be embodied, for example, as computer memory located on a computing device that is supporting the execution of the content presentation module (200), on network storage that is accessible by computing device that is supporting the execution of the content presentation module (200), and so on. In the example method of FIG. 4, the one or more elements (404) in the user profile (202) that were identified in the request (224) may be stored (406) in memory (402) such that the content presentation module (200) may identify the specific elements from the user profile (202) that were used by the content provider (228) to generate content (222) whose presentation the user (226) may desire to change.

The example method of FIG. 4 also includes presenting (408), by the content presentation module (200), a user interface for altering the one or more elements in the user profile (202) identified in the request (224) for one or more elements in the user profile (202). In the example method of FIG. 4, the graphical user interface may include information identifying the one or more elements (204, 206) in the user profile (202) that were identified in the request (224) received (208) by the content presentation module (200). The graphical user interface may also include text boxes, drop down lists, and other input fields that allow the user (226) to specify an updated value (218) for one or more of the elements (204, 206) in the user profile (202) that were identified in the request (224) that was received (208) by the content presentation module (200).

Example embodiments of the present invention are described largely in the context of a fully functional computer system for modifying a user profile. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the example embodiments described in this specification are oriented to software installed and executing on computer hardware, nevertheless, alternative embodiments implemented as firmware or as hardware are well within the scope of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method of modifying a user profile, the method comprising:
receiving, by a content presentation module, a request for one or more elements in a user profile, wherein each element in the user profile includes information identifying attributes associated with a user;
presenting, by the content presentation module, content provided by a content provider;
receiving, by the content presentation module, a user request to alter the presentation of the content;
receiving, by the content presentation module, updated values for the requested one or more elements in the user profile; and
updating, by the content presentation module, the user profile in dependence upon the updated values for the requested one or more elements in the user profile.

2. The method of claim 1 wherein the requested one or more elements in the user profile are a subset of all elements in the user profile.

3. The method of claim 1 further comprising sending, by the content presentation module, a request for content.

4. The method of claim 1 further comprising prompting, by the content presentation module, the user to issue the user request to alter the presentation of the content.

5. The method of claim 1 further comprising storing, by the content presentation module in memory accessible by the content presentation module, the requested one or more elements in the user profile.

6. The method of claim 1 further comprising presenting, by the content presentation module, a user interface for altering the one or more elements in the user profile identified in the request for one or more elements in the user profile.

7-20. (canceled)
